(19) United States
(12) Patent Application Publication
(10) Pub. No.: US 2013/0093307 A1
(43) Pub. Date: Apr. 18, 2013

(54) LED LAMP HAVING TWO LAYERS OF FLUORESCENT POWDER

(71) Applicant: Yung Pun Cheng, Hong Kong (CN)

(72) Inventor: Yung Pun Cheng, Hong Kong (CN)

(21) Appl. No.: 13/648,884

(22) Filed: Oct. 10, 2012

(30) Foreign Application Priority Data
Oct. 14, 2011 (CN) 201120395577.9

(51) Int. Cl. H05B 33/14; H05B 33/02

(52) U.S. Cl. 313/36; 313/503

(57) ABSTRACT

An LED lamp has two layers of fluorescent powder, wherein a blue light of 400-530 nm emitted by a blue light LED chip first irradiates on an inner layer of silicate fluorescent powder to excite a light of a higher wavelength which is then emitted to an outer layer of YAG fluorescent powder, so as to obtain an ideal warm white light. The yellow light excited by the silicate fluorescent powder re-excites YAG fluorescent powder to obtain a warm white light having a higher color rendering index, while a light source with an area several times greater than that of the original chip obtained by exciting the inner layer of silicate fluorescent powder can re-excite the YAG fluorescent powder to multiply the excitation effect.

This application claims priority to Chinese Patent Application No. 201120395577.9, entitled “LED Lamp Having Two Layers of Fluorescent Powder,” filed Oct. 14, 2011, which is hereby incorporated by reference in its entirety for all purposes.

### TECHNICAL FIELD

This invention generally relates to a white light LED lighting device, more particularly to an LED light emiting a desirable warm white light by double excitation of two fluorescent powder layers.

### BACKGROUND

With technology development, more and more white light LED lamps are commonly utilized in the lighting field. Compared with an incandescent lamp, a white light LED lamp has advantages of less bulk, less heat generation, less power consumption, longer lifetime, faster response speed, and more environmental friendliness, etc., therefore it is more promising.

Currently, a white light with various color rendering indexes may be generated by a combination of a plurality of monochromatic LED chips or combination of monochromatic LED chips with fluorescent powder. For example, a white light can be generated by combination of red light chips, blue light chips and green light chips. However, generating a white light in this way may be disadvantageous due to high manufacturing cost. As another example, white light can be generated by a blue light chip coated with yellow fluorescent powder (e.g., yttrium aluminum garnet (YAG) fluorescent powder). However, generating a white light in this way may also be disadvantageous due to the low color rendering index of the white light and the fluorescent powder's susceptibility to aging. For example, the excited light may have a color rendering index of only about 70. As such, although YAG fluorescent powder has been employed for almost 20 years, YAG fluorescent powder has not been used on its own to excite ideal warm white light until recently.

In addition, currently, white light is usually obtained by using an LED chip with a relatively small area to directly excite the fluorescent powder coated onto the surface or outer casing, which limits the effective lighting area and light intensity of the LED lamp.

Therefore, there is a need for a new LED lighting device which is able to prominently improve the color rendering index of white light and increase lighting area as well as light intensity.

### SUMMARY

According to the present invention, an LED lamp having two layers of fluorescent powder is provided, which is characterized in that it comprises: blue light LED chips; an inner cover which contains silicate fluorescent powder and covers the blue light LED chips; and an outer cover which contains YAG or silicate fluorescent power and covers outside of the inner cover.

In a further embodiment, both the inner and outer covers are self-supported.

In a further embodiment, both the inner and outer covers are casings formed by mixing fluorescent powder and transparent molding materials.

In a further embodiment, transparent cooling liquid is filled between the inner and outer covers as well as inside the inner cover.

In a further embodiment, the LED lamp further comprises a transparent casing, and the inner and outer covers are fluorescent powder layers coated on the inner surface and the outer surface of the transparent casing, respectively.

In a further embodiment, the transparent casing is made of glass or transparent polymer.

In a further embodiment, the transparent casing is 1-3 mm in thickness.

In a further embodiment, transparent cooling liquid is filled inside the transparent casing.

The present invention has the following advantage: an ideal warm white light with a high color rendering index can be obtained by double excitation, that is, the blue light of 400-530 nm emitted by the LED chip irradiates on the silicate fluorescent powder to excite higher wavelength light, and the higher wavelength light in turn irradiates on further outer silicate fluorescent powder to re-excite. In addition, the present invention utilizes an LED chip of a very small area to excite a silicate fluorescent powder cover of tens of times that area, so as to obtain a light source having a light intensity several times greater than that of the original chip, and this light source re-excites the outer YAG fluorescent powder or silicate fluorescent powder cover to obtain a multiplied excitation effect.

### BRIEF DESCRIPTION OF THE DRAWINGS

FIG. 1a shows a schematic sectional view of a first embodiment of an LED lamp according to the present invention.

FIG. 1b shows a schematic sectional detail view of the first embodiment of the LED lamp according to the present invention, with hollow cavities between the led chip and inner cover and between the inner cover and outer cover.

FIG. 1c shows a schematic sectional detail view of the first embodiment of the LED lamp according to the present invention, with thermal insulation filling the cavities between the LED chip(s) and inner cover and between the inner cover and outer cover.

FIG. 2a shows a schematic sectional view of a second embodiment of the LED lamp according to the present invention.

FIG. 2b shows a schematic sectional detail view of the second embodiment of the LED lamp according to the present invention.

FIG. 2c shows a schematic sectional detail view of the second embodiment of the LED lamp according to the present invention, with thermal insulation filling a cavity formed in the transparent casing.

FIG. 2d shows a schematic sectional detail view of the second embodiment of the LED lamp according to the present invention, with thermal insulation filling a cavity formed in the transparent casing as well as a cavity between the transparent casing and the LED chip(s).

### DETAILED DESCRIPTION

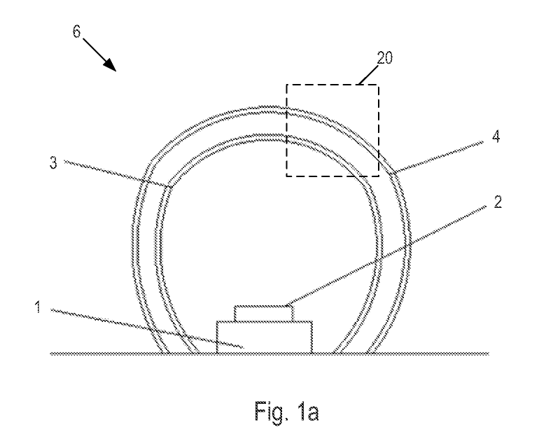

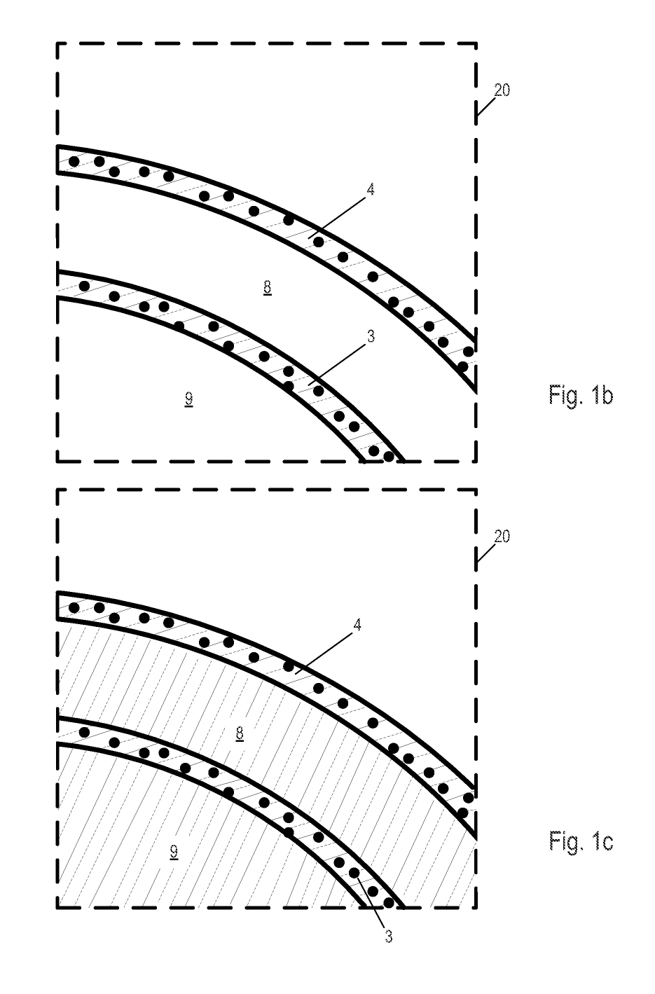

Hereinafter the preferred embodiments of the present invention will be described in connection with the Drawings. Referring to FIG. 1a first, the figure schematically shows a sectional view of one embodiment of an LED lamp according to the present invention. The LED lamp 6 shown in FIG. 1 a comprises one or more blue light LED chips 2 arranged on a support 1, an inner cover 3, and an outer cover 4. The chips can be adhered to the support through transparent die-attaching adhesive or in other ways. The arrangement of the chips can be determined according to practical requirements; for example, the chips can be arranged in one or two dimensions, or in concentric circles for uniform lighting. Of course, other arrangements are also conceivable. The chips can be fixed to the support by conventional setup techniques, or the chips may be vertically set up together with the support. When the diode is turned on, the front face of the LED chips on the vertical transparent support normally radiates. Meanwhile, the bottom of the LED chips also radiates brighter light through the transparent support. Therefore, LED light extraction can be improved by eliminating the limitation that supply wires prevent the LED from demonstrating its brightest face due to current packaging technology.

The LED lamp according to the present invention employs two kinds of fluorescent powder, e.g., YAG fluorescent powder and silicate fluorescent powder, to obtain ideal warm white light. As the most commonly used fluorescent powder in the art, YAG fluorescent powder mainly consists of aluminium oxide, yttrium oxide, and a small amount of cerium oxide, and a small amount of gadolinium and potassium, etc. may be added as well. YAG fluorescent powder can generate yellow light when excited by blue light, and white light can be obtained by mixing the yellow light and the blue light. Silicate fluorescent powder utilizes silicon dioxide, strontium carbonate, and barium carbonate as the base material, and emits light with a wavelength adjustable between 507-610 nm. The silicate fluorescent powder described herein may comprise green powder (having components of barium (Ba) 0.8 strontium (Sr) 0.2 silicon (Si), oxygen (0), europium (Eu) 0.02) and red powder (having components of barium (Ba) 0.05, strontium (Sr) 2.9, silicon (Si), magnesium (Mg) 0.05, oxygen (O), europium (Eu) 0.02). Silicate fluorescent powder has advantages in substantially absorbing ultraviolet light, near ultraviolet light, and blue light, and emitting light covering a wide wavelength range (e.g., waveband), which provides good emission effects from green light to orange light, and capability for users to adjust the spectrum as desired.

Specifically, in the embodiment shown in FIG. 1a, the inner cover 3 covering outside the blue light LED chip 2 contains silicate fluorescent powder, and the outer cover 4 contains YAG fluorescent powder, and optionally, silicate fluorescent powder. In normal operation, when it is powered, the LED chip 2 emits blue light with a wavelength between 400-530 nm which irradiates on the silicate fluorescent powder of the inner cover. The silicate fluorescent powder is excited by the irradiation from the blue light, and converts the blue light into light with a wavelength between 402-550 nm (the waveband is increased by 0.5-10%). The light of higher wavelength further irradiates onto the YAG fluorescent powder or silicate fluorescent powder of the outer cover and is converted into a light of another wavelength (e.g., yellow light). The excited lights and the transmited lights of various wavelengths are mixed into warm white light with a color rendering index of more than 80.

In another aspect, the inner cover 3 containing silicate fluorescent powder together with LED chip(s) 2 can be regarded as a special illuminant, which utilizes LED chip(s) of very small area to excite a silicate fluorescent powder cover with an area that is tens of times greater than that of the chip, so as to obtain a light source with an effective lighting area that is several times greater than the original wafer, wherein the light from the light source re-excites the outside YAG fluorescent powder or silicate fluorescent powder cover to realize a multiplied excitation effect.

In this embodiment, both the inner cover 3 and the outer cover 4 are self-supported, that is to say, both are independent covers with a distance therebetween, for example, 0.1-3 mm To this end, these covers can be made of a mixture of fluorescent powder and transparent molding materials, as shown in FIGS. 1b and 1c which provide a detail view of section 20 of LED lamp 6. For example, fluorescent powder and transparent polymer or glass can be mixed by heating and molded to form the covers. Further, as shown in FIG.. 1b, a cavity 8 between the inner cover 3 and the outer cover 4 may be hollow, and a cavity 9 inside the inner cover 3 may also be hollow. However, preferably, transparent cooling liquid can fill cavities 8 and 9, to expedite dissipation of heat generated by the LED chip(s).

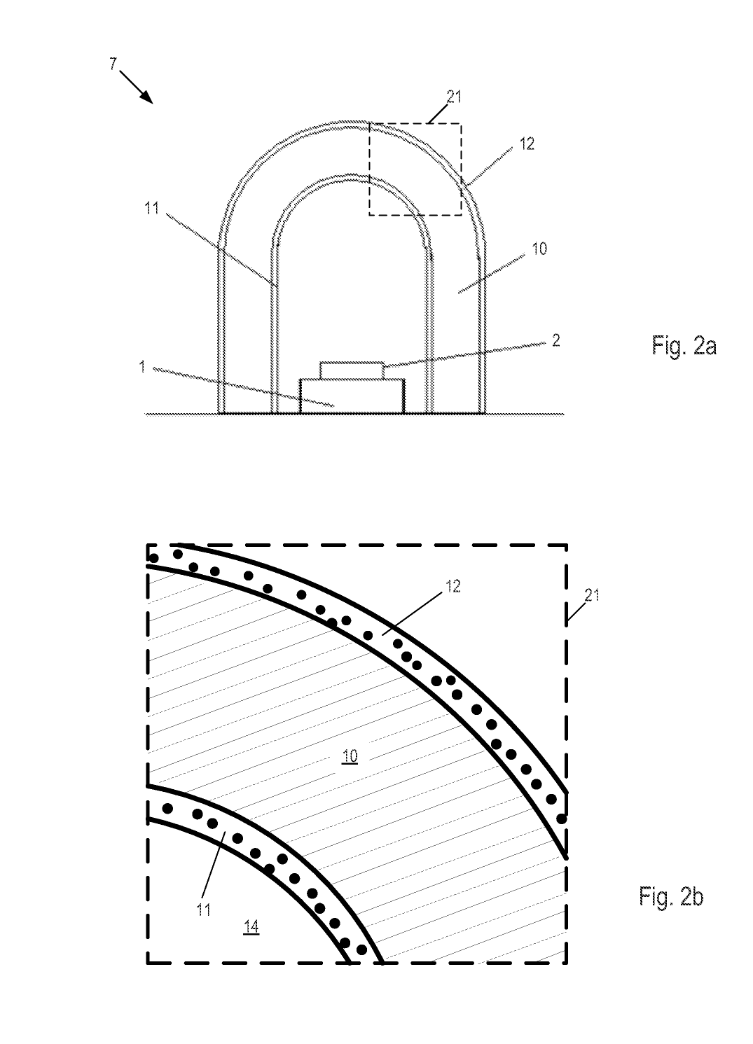

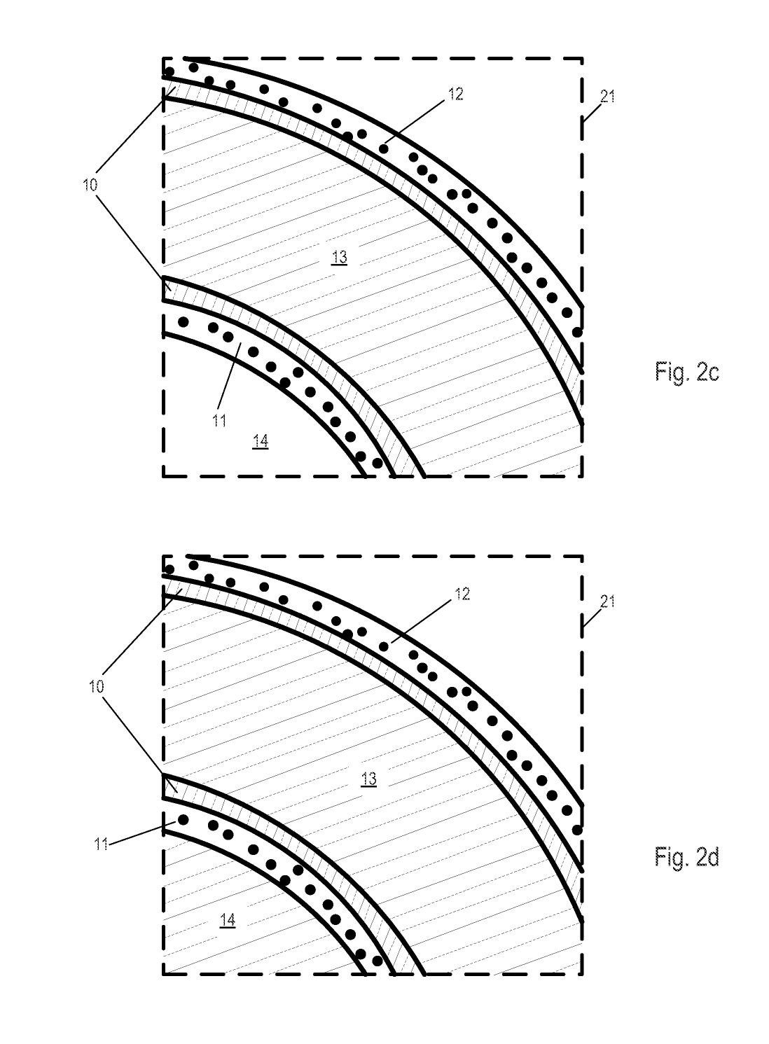

Another embodiment of an LED lamp, LED lamp 7, is shown in FIG. 2a. FIGS. 2b, 2c, and 2d provide a detail view of section 21 of LED lamp 7. In contrast to the embodiment shown in FIG. 1a, LED lamp 7 of FIG. 2a further comprises a transparent casing 10. In this embodiment, an inner cover 11 and an outer cover 12 are fluorescent powder layers coated onto the inner surface and outer surface, respectively, of the transparent casing 10. The transparent casing 10 can be made of transparent materials, such as glass or polymer, as shown in FIG. 2a. The transparent casing may have a thickness of 1-3 mm, and the coated fluorescent powder layers may each have a thickness between 0.1-1.5 mm In one example, as shown in FIG. 2b, the transparent casing does not include a cavity. In another example, as shown in FIG. 2c, transparent cooling liquid fills a cavity 13 formed in the casing 10 to expedite the heat dissipation of the LED chip(s). In yet another example, as shown in FIG. 2d, transparent cooling liquid fills both cavity 13 and a cavity 14 between the inner surface of transparent casing 10 and the LED chip(s). While not shown, in some examples, transparent casing 10 may not include a cavity, and transparent cooling liquid may fill only cavity 14.

Although FIG. 1a shows an LED lamp with a circular or oval profile and FIG. 2a shows a cylindrical LED lamp with a convex crest, the present invention is not limited thereby, and other shapes such as a square LED lamp are also conceivable. In addition, it is apparent to those skilled in the art that the embodiment of FIG. 1a can advantageously employ the shape shown in FIG. 2a, that is to say, the inner cover 3 and outer cover 4 shown in FIG. 1a can be designed as nested test tubes to facilitate manufacture and assembly.

Although the present invention has been described in detail in connection with the embodiments shown in the figures, it is to be understood by those skilled in the art that other embodiments may provide the same results. Variations and modifications to the present invention are obvious to those skilled in the art and within the scope of the present invention.

1. An LED lamp having two layers of fluorescent powder, comprising:
one or more blue light LED chips;
an inner cover which contains silicate fluorescent powder and covers the one or more blue light LED chips; and
an outer cover which contains YAG fluorescent powder or silicate fluorescent power and covers outside of the inner cover.

2. The LED lamp of claim 1, wherein both the inner and outer covers are self-supported.

3. The LED lamp of claim 2, wherein both the inner and outer covers are casings formed by mixing fluorescent powder and transparent polymer or glass.

4. The LED lamp of claim 3, wherein transparent cooling liquid fills a cavity between the inner and outer covers as well as a cavity inside the inner cover.

5. The LED lamp of claim 1, wherein the LED lamp further comprises a transparent casing, and the inner and outer covers are fluorescent powder layers coated on the inner surface and the outer surface of the transparent casing, respectively.

6. The LED lamp of claim 5, wherein the transparent casing is made of glass or transparent polymer.

7. The LED lamp of claim 5, wherein the transparent casing is 1-3 mm in thickness.

8. The LED lamp of claim 7, wherein transparent cooling liquid fills a cavity between the inner and outer surfaces of the transparent casing.

9. The LED lamp of claim 1, wherein the outer cover contains YAG fluorescent powder.

10. The LED lamp of claim 1, wherein the outer cover contains silicate fluorescent powder.

11. The LED lamp of claim 1, wherein the inner and outer covers are designed as nested test tubes.

12. An LED lamp having two layers of fluorescent powder, comprising:
one or more blue light LED chips;
an inner cover which contains silicate fluorescent powder and covers the one or more blue light LED chips; and
an outer cover which contains YAG fluorescent powder or silicate fluorescent power and covers outside of the inner layer;
wherein the outer and inner covers are independent covers with a distance therebetween.

13. The LED lamp of claim 12, wherein the inner cover is a casing formed by mixing silicate fluorescent powder and transparent polymer or glass, and wherein the outer cover is a casing formed by mixing YAG fluorescent powder or silicate fluorescent powder and transparent polymer or glass.

14. The LED lamp of claim 13, wherein transparent cooling liquid fills a cavity between the inner and outer covers as well as a cavity inside the inner cover.

15. The LED lamp of claim 14, wherein the distance between the outer and inner covers is 0.1-3 mm

16. An LED lamp having two layers of fluorescent powder, comprising:
one or more blue light LED chips;
a transparent casing;
an inner cover coated on an inner surface of the transparent casing, the inner cover containing silicate fluorescent powder and covering the one or more blue light LED chips; and
an outer cover coated on an outer surface of the transparent casing, the outer cover containing YAG fluorescent powder or silicate fluorescent power and covering outside of the inner cover.

17. The LED lamp of claim 16, wherein the transparent casing is made of glass or transparent polymer.

18. The LED lamp of claim 17, wherein the transparent casing is 1-3 mm in thickness.

19. The LED lamp of claim 18, wherein transparent cooling liquid fills a cavity between the inner and outer surfaces of the transparent casing.

20. The LED lamp of claim 19, wherein the inner and outer covers are each 0.1-1.5 mm in thickness.
